(19) United States
(12) Patent Application Publication
(10) Pub. No.: US 2017/0222233 A1
(43) Pub. Date: Aug. 3, 2017

(54) FUEL CELL DEVICE

(71) Applicant: Robert Bosch GmbH, Stuttgart (DE)

(72) Inventors: Andre Moc, Grossschoenau (DE); Piero Lupetin, Stuttgart (DE)

(21) Appl. No.: 15/500,327

(22) PCT Filed: Jul. 27, 2015
(86) PCT No.: PCT/EP2015/067136

§ 371 Date: Jan. 30, 2017

(30) Foreign Application Priority Data
Jul. 28, 2014 (DE) 102014214781.6

(51) Int. Cl. H01M 8/0236; H01M 8/0256; H01M 8/0245; H01M 8/2425; H01M 8/12

(52) U.S. Cl. CPC H01M 8/0236; H01M 8/2425; H01M 8/12; H01M 8/0245; H01M 8/0256; H01M 2008/1293

(57) ABSTRACT

The invention relates to a fuel cell device comprising a fuel cell unit (10) which comprises at least two fuel cells (12, 14) and an interconnection unit (16) which is provided to serially interconnect the at least two fuel cells (12, 14). According to the invention, the at least one interconnection unit (16) comprises at least two layers (18, 20) which are made from different materials.

### BACKGROUND OF THE INVENTION

The invention relates to a fuel cell device.

There have already been proposals for a fuel cell device having a fuel cell unit which comprises a plurality of fuel cells. The fuel cells are connected serially by means of an interconnector unit. This interconnector unit is formed only of one material.

### SUMMARY OF THE INVENTION

The starting point for the invention is a fuel cell device having a fuel cell unit which comprises at least two fuel cells and an interconnector unit which is intended for serially interconnecting the at least two fuel cells.

The proposal is that the at least one interconnector unit have at least two laminae which are formed of materials different from one another.

A “fuel cell device” in this context is intended in particular to refer to a device for stationary and/or mobile production in particular of electrical and/or thermal energy, using at least one fuel cell unit. A “fuel cell unit” is intended in this context to refer in particular to a unit having a plurality of interconnected fuel cells, which is intended to convert at least one chemical energy of at least one combustion gas, more particularly hydrogen and/or carbon monoxide, and of at least one oxidizing agent, more particularly oxygen, into electrical energy in particular. The fuel cells are designed preferably as solid oxide fuel cells (SOFCs). “Intended” is to mean, in particular, specially programmed, designed and/or equipped. The statement that an object is intended for a particular function is to mean more particularly that the object fulfills and/or executes this particular function in at least one application state and/or operating state. An “interconnector unit” is intended in this context to refer in particular to a unit which is intended to produce an electrically conducting connection between the at least two fuel cells, in order to connect the at least two fuel cells serially to one another.

The at least one interconnector unit is formed in particular of materials which are different from one another and which are disposed in layers one against another. The materials of which the interconnector unit is formed have, in particular, complementary and/or supplementary functional properties, particularly with regard to conductivity and/or sintering behavior. The materials of the interconnector unit preferably each have a perovskite structure.

By means of such a design it is possible to provide a generic fuel cell device having improved operating properties. In particular, by forming the interconnector unit from materials different from one another, it is possible to achieve advantageous combination of physical properties. As a result, the interconnector unit can be adapted advantageously to requirements of a fuel cell device, enabling an advantageous boost in particular to functionality and/or lifetime of the fuel cell device.

A further proposal is that the interconnector unit have at least one first lamina which is formed of a manganese-based perovskite. The manganese-based perovskite has, in particular, the general chemical formula La₁₋ₓSrₓA_{y}Mn_{1-y}O₃, where 0.05<x<0.6, 0.05<y<0.6, and A=scandium (Sc), titanium (Ti), niobium (Nb) or tantalum (Ta). The effect achievable by this means is that the at least one first lamina has a high electrical conductivity particularly under a reducing atmosphere, as for example an anodic atmosphere. The interconnector unit preferably has at least one second lamina, which is formed of a nickel-based perovskite. The nickel-based perovskite has, in particular, the general chemical formula LaNiₓFe₁₋ₓO₃, where 0.05<x<0.6. By this means it is possible to create an advantageously gastight second lamina, thus allowing the gastight nature of the fuel cell device to be advantageously increased. Furthermore, an advantageously high conductivity of the at least one second lamina under a cathodic atmosphere can be achieved. Through the combination of the at least one first lamina and the at least one second lamina to form an interconnector unit, therefore, ohmic losses can be advantageously reduced, since an advantageously high conductivity can be achieved both in an anodic atmosphere and in a cathodic atmosphere.

In a further proposal, the fuel cell unit is to comprise at least one cathode layer, which is intended for forming cathodes of the at least two fuel cells, at least one anode layer, which is intended for forming anodes of the at least two fuel cells, and at least an electrolyte layer, which is intended for forming electrolytes of the at least two fuel cells. The at least one cathode layer may be formed more particularly of lanthanum strontium manganese oxide and/or lanthanum strontium scandium manganese oxide and/or lanthanum strontium cobalt iron oxide and/or lanthanum nickel iron oxide. The cathode layer is preferably formed of lanthanum strontium manganese oxide, lanthanum strontium scandium manganese oxide or a mixture thereof. The material of the at least one cathode layer preferably has a perovskite structure. The at least one anode layer may be formed more particularly of a cermet comprising nickel and yttrium-stabilized zirconium oxide and/or of lanthanum strontium titanium oxide and/or lanthanum strontium scandium manganese oxide. The at least one electrolyte layer may be formed more particularly of yttrium-stabilized zirconium oxide and/or scandium-stabilized zirconium oxide. The at least one electrolyte layer is disposed in particular between the at least one anode layer and the at least one cathode layer. The at least one cathode layer forms a cathode of each of the at least two fuel cells, and the cathodes of the at least two fuel cells are preferably separated from one another by an electrical and ionic insulator. The at least one anode layer forms an anode in each of the at least two fuel cells, and the anodes of the at least two fuel cells are preferably separated from one another by an electrical and ionic insulator. This allows an advantageous construction to be achieved for the at least two fuel cells.

A further proposal is that the at least two fuel cells be disposed within the fuel cell unit in such a way that a cathode of a first fuel cell at least partially overlaps an anode of a second fuel cell. This allows an advantageously compact construction to be achieved for the fuel cell unit.

It is proposed, moreover, that the interconnector unit be disposed within the electrolyte layer of the fuel cell unit. The interconnector unit is intended in particular to connect in series a cathode of a first fuel cell to an anode of a second fuel cell. The interconnector unit is more particularly disposed within the electrolyte layer of the fuel cell unit in such a way that it separates an electrolyte of a first fuel cell, especially in an ionically insulating manner, from an electrolyte of a second fuel cell. The interconnector unit is disposed more particularly in a region of the electrolyte layer in which there is at least partial overlap of a cathode of a first fuel cell and an anode of a second fuel cell. In this way it is possible to realize a fuel cell unit having advantageously large electrochemically active areas.

It is proposed, furthermore, that the at least one first lamina of the interconnector unit point in the direction of the at least one anode layer, and the at least one second lamina of the interconnector unit point in the direction of the at least one cathode layer. By this means, an advantageous disposition of the laminae of the interconnector unit can be achieved within the fuel cell unit, particularly with regard to the orientation of the materials of the interconnector unit.

A further proposal is that the fuel cell device comprise at least one base body on which the fuel cell unit is disposed. A “base body” in this context is intended to refer in particular to an element which is intended in particular to mechanically relieve and/or stabilize the at least one fuel cell unit. An advantageously thin design of the fuel cell unit, in particular, is made possible as a result. By reducing the thickness of the at least one electrolyte layer it is possible, in particular, advantageously to improve the conductivity of the electrolytes of the at least two fuel cells and hence advantageously to boost the efficiency of the fuel cells. The base body may in particular be tubular in design. For example, the base body may have a fastening section, more particularly a gastight fastening section, at one open tube end at least, for fastening of the base body to a carrier substrate. At another tube end, the base body may have a further such fastening section or, in particular, may be sealed by a cap section, more particularly a gastight cap section. The fuel cell unit is disposed on the base body in particular in such a way that, preferably, the at least one cathode layer adjoins the base body. In regions in which the fuel cell unit adjoins the base body, the base body is preferably of gas-permeable form and has, for example, gas-permeable pores and/or openings. The base body may be formed in particular of one or more ceramic and/or vitreous materials. For example, the base body may be formed of forsterite and/or zirconium dioxide and/or aluminum oxide. In this way, advantageous mechanical and/or thermal stability can be achieved for the fuel cell device.

Also proposed is a method for producing a fuel cell device of the invention. In particular, in at least one method step, at least the interconnector unit and preferably the entire fuel cell unit can be produced by screen printing. In at least one further method step, in particular, the materials of the interconnector unit and/or of the fuel cell unit and/or of the base body can be co-sintered. In this way, an advantageously simple and/or inexpensive production can be achieved for the fuel cell device of the invention.

The fuel cell device of the invention is not intended to be confined here to the above-described application and embodiment. In particular, for fulfilling a mode of functioning that is described herein, the fuel cell device of the invention may have a number of individual elements, components, and units that differs from any number specified herein.

### BRIEF DESCRIPTION OF THE DRAWINGS

Further advantages will become apparent from the following description of the drawing. The drawing shows an exemplary embodiment of the invention. The drawing, the description, and the claims contain numerous features in combination. The skilled person will also look at the features individually, usefully, and assemble them to form rational further combinations.

FIG. 1 shows a schematic cross section through a fuel cell device having a fuel cell unit which comprises at least two fuel cells which are serially interconnected by means of a bilaminar interconnector unit.

### DETAILED DESCRIPTION

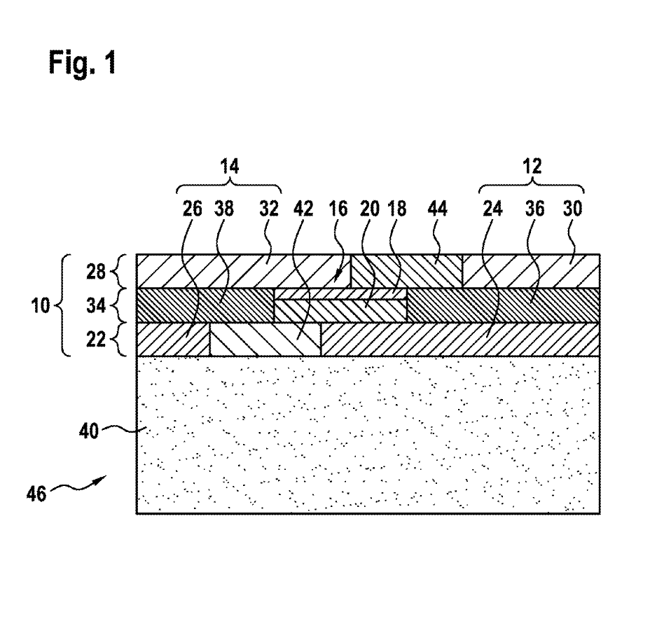

FIG. 1 shows a schematic cross section through a fuel cell device 46, which is here shown only in part. The fuel cell device 46 comprises a fuel cell unit 10, which here, as an example, comprises two serially connected fuel cells 12, 14. The fuel cells 12, 14 are connected in series via an interconnector unit 16.

As shown by FIG. 1, the fuel cell unit 10 is designed as a multilaminar layer system, with the fuel cells 12, 14 formed substantially alongside one another. The fuel cell unit 10 here comprises a cathode layer 22, an electrolyte layer 34, and an anode layer 28. The cathode layer 22 here forms the cathodes 24, 26 of the fuel cells 12, 14. The anode layer 28 here forms the anodes 30, 32 of the fuel cells 12, 14. The electrolyte layer 34 here forms the electrolytes 36, 38 of the fuel cells 12, 14.

The interconnector unit 16 is disposed entirely within the electrolyte layer 34. In particular, the interconnector unit 16 is disposed in such a way that the cathode 24 of the first fuel cell 12 is connected in series with the anode 32 of the second fuel cell 14 via the interconnector unit 16. The electrolyte 36 of the first fuel cell 12 here is separated, in particular in an ionically insulating manner, by the interconnector unit 16 from the electrolyte 38 of the second fuel cell 14.

FIG. 1 illustrates further how the cathodes 24, 26 of the fuel cells 12, 14 are separated from one another by an electrically and ionically insulating region 42, and the anodes 30, 32 of the fuel cells 12, 14 by at least one electrically and ionically insulating region 44. In the embodiment shown in FIG. 1, moreover, the cathodes 24, 26 and the anodes 30, 32 of the fuel cells 12, 14 are formed by the cathode layer 22 and by the anode layer 28, respectively, in such a way that the cathode 24 of the first fuel cell 12 partially overlaps the anode 32 of the second fuel cell 14. Within the overlapping region, the interconnector unit 16 here is disposed in the electrolyte layer 34. Alternatively, however, there may be no overlapping of an anode and a cathode.

FIG. 1 shows, furthermore, that the fuel cell device 46 has a base body 40. The base body 40 may be formed, for example, of one or more ceramic and/or vitreous materials. In principle, the base body 40 may be either a base body of tubular design or else a base body of planar design. The fuel cell device 46, therefore, may be formed either as a planar fuel cell device or else, preferably, as a tubular fuel cell device. The fuel cell unit 10 here may be applied in particular on an inside or on an outside, but preferably, as shown here, on the inside, of the base body 40. As illustrated by FIG. 1, the cathodes 24, 26 of the fuel cells 12, 14 and/or the cathode layer 22 of the fuel cell unit 10 adjoin the base body 40. The anodes 30, 32 of the fuel cells 12, 14 and/or the anode layer 28 of the fuel cell unit 10 here is open or is freely accessible. In the section adjoining the fuel cells 12, 14, the base body 40 has gas-permeable pores and/or openings.

The interconnector unit 16 is bilaminar. A first lamina 18 of the interconnector unit 16 is formed at least substantially of a manganese-based perovskite. The manganese-based perovskite has the general chemical formula La₁₋ₓSrₓA_{y}Mn_{1-y}O₃, where 0.05<x<0.6, 0.05<y<0.6, and A=scandium (Sc), titanium (Ti), niobium (Nb) or tantalum (Ta). A second lamina 20 of the interconnector unit 16 is formed at least substantially of a nickel-based perovskite. The nickel-based perovskite has the general chemical formula LaNiₓFe₁₋ₓO₃, where 0.05<x<0.6. The laminae 18, 20 of the interconnector unit 16 are disposed in such a way that the first lamina 18 of the interconnector unit 16 points in the direction of the anode layer 28, and the second lamina 20 of the interconnector unit 16 points in the direction of the at least one cathode layer 22.

Through the first lamina 18, which is formed at least substantially of the manganese-based perovskite, the interconnector unit 16, particularly in an anodic atmosphere, has a sufficiently high conductivity (5 S/cm at 850° C.). At the same time, the first lamina 18 protects the underlying second lamina 20, which is formed at least substantially of the nickel-based perovskite, from harmful effects of the anodic atmosphere. By virtue of the good sintering properties of the nickel-based perovskite, the second lamina 20 is of advantageously gastight design, thereby making it possible to prevent emergence of fuel gas from the fuel cell device 46, advantageously. Through the bilaminar construction of the interconnector unit 16, the positive physical properties of the manganese-based perovskite of the first lamina 18 and of the nickel-based perovskite of the second lamina 20 are combined advantageously with one another.

1. A fuel cell device having a fuel cell unit (10) which comprises first and second fuel cells (12, 14) and an interconnector unit (16) serially interconnecting the fuel cells (12, 14), characterized in that the at least one interconnector unit (16) has first and second laminae (18, 20) which are formed of materials different from one another.

2. The fuel cell device as claimed in claim 1, characterized in that the first lamina (18) is formed of a manganese-based perovskite.

3. The fuel cell device as claimed in claim 1, characterized in that the second lamina (20) is formed of a nickel-based perovskite.

4. The fuel cell device as claimed in claim 1, characterized in that the fuel cell unit (10) comprises at least one cathode layer (22) forming cathodes (24, 26) of the fuel cells (12, 14), at least one anode layer (28) forming anodes (30, 32) of the fuel cells (12, 14), and at least one electrolyte layer (34) forming electrolytes (36, 38) of the fuel cells (12, 14).

5. The fuel cell device as claimed in claim 4, characterized in that the fuel cells (12, 14) within the fuel cell unit (10) are disposed in such a way that one of the cathodes (24) of the first fuel cell (12) at least partially overlaps one of the anodes (32) of the second fuel cell (14).

6. The fuel cell device at least as claimed in claim 4, characterized in that the interconnector unit (16) is disposed within the electrolyte layer (34) of the fuel cell unit (10).

7. The fuel cell device as claimed in claim 6, characterized in that the first lamina (18) of the interconnector unit (16) points in the direction of the at least one anode layer (28), and the second lamina (20) of the interconnector unit (16) points in the direction of the at least one cathode layer (22).

8. The fuel cell device as claimed in claim 1, characterized by at least one base body (40) on which the fuel cell unit (10) is disposed.

9. (canceled)

10. The fuel cell device as claimed in claim 2, characterized in that the second lamina (20) is formed of a nickel-based perovskite.
